(19) United States
(12) Patent Application Publication
(10) Pub. No.: US 2015/0329008 A1
(43) Pub. Date: Nov. 19, 2015

(54) BATTERY SYSTEMS OPERABLE IN A BACKUP MODE AND RELATED METHODS

(71) Applicant: GM GLOBAL TECHNOLOGY OPERATIONS LLC, DETROIT, MI (US)

(72) Inventors: PETER T. KARLSON, WHITBY (CA); VYACHESLAV BEREZIN, NEWMARKET (CA); THOMAS A. JONES, MACOMB, MI (US)

(73) Assignee: GM GLOBAL TECHNOLOGY OPERATIONS LLC, DETROIT, MI (US)

(21) Appl. No.: 14/279,042

(22) Filed: May 15, 2014

(51) Int. Cl. B60L 11/18; B60W 10/26; B60W 40/02; H02J 7/00

(52) U.S. Cl. CPC B60L 11/1862; H02J 7/007; B60W 10/26; B60W 40/02; B60W 2510/244; B60W 2550/12; B60W 2710/244

(57) ABSTRACT

The present disclosure pertains to various embodiments of battery systems and related methods that may operate in a preconditioning mode based upon a predicted disturbance of service of an electrical utility. Such systems may include a battery configured to store electrical energy. A communication module may be configured to receive an indication of a predicted disturbance of an electrical utility. A battery management system may operate the battery system in a normal mode to maintain a state of charge (SOC) of the battery system within a normal mode SOC range. Upon receipt of an indication of the predicted disturbance from the communication module, the battery system may be transitioned to a preconditioning mode. The state of charge may be maintained within a preconditioning mode SOC range that exceeds the normal SOC range. The battery system may provide electrical energy during an actual disturbance affecting the electrical utility.

### TECHNICAL FIELD

This disclosure relates to battery systems and methods configured to store electrical energy that may be used during a potential disruption in service by an electrical utility. More specifically, this disclosure relates to identification of an event that may result in disruption of service of an electrical utility and operating the battery system in a preconditioning mode in advance of the potential disruption to increase the available electrical energy in the event of an actual disruption of electrical service.

### BACKGROUND

Passenger vehicles often include electric batteries for operating a vehicle's electrical and drivetrain systems. For example, vehicles may include a 12V lead-acid automotive battery configured to supply electric energy to vehicle starter systems (e.g., a starter motor), lighting systems, and/or ignition systems. In electric, fuel cell (“FC”), and/or hybrid vehicles, a high voltage (“HV”) battery system may be used to power electric drivetrain components of the vehicle (e.g., electric drive motors and the like). Such battery systems may permit storage of a considerable amount of electrical energy that may be used to move the vehicle.

Battery systems may also be included in stationary applications for a variety of purposes. For example, a battery backup system may be used to provide temporary power to a building during an interruption of electric service provided by an electric utility. In another example, a renewable energy source (e.g., solar, wind, etc.) may be connected to a battery system to level the energy output of the renewable energy system.

In operation, a battery system may be maintained within a state of charge (SOC) range that is narrower than the battery system's physical limitations for charging and discharging. The SOC range may depend on the use to which the battery system is put. A battery system used to provide backup power may be maintained at a relatively high SOC to maximize the amount of electrical energy available in the event of a power outage. The SOC of a battery system used in connection with a renewable energy source may be generally maintained at an SOC that permits the system to absorb electrical energy when it is available from the renewable source.

A battery management system may selectively terminate battery discharge at a threshold level. The threshold for terminating further battery discharge may be based on a monitored voltage or other parameters of the battery as a whole. Failure to restrict further discharge of the battery below an over-depletion threshold may result in battery system inefficiencies, degradation, permanent damage, and/or a shortened usable lifespan. Similarly, charging of the battery may terminate at a SOC upper threshold level that is less than the total energy storage capacity of the battery system.

### SUMMARY

The present disclosure pertains to various embodiments of battery systems and related methods that may operate in a preconditioning mode based upon a predicted disturbance of service of an electrical utility. Such systems may include a battery configured to store electrical energy. A communication module may be configured to receive an indication of a predicted disturbance of an electrical utility. In various embodiments, the communication module may be a wireless data network interface, a wired data network interface, a cellular data interface, a satellite data interface, and a radio data system interface. A battery management system may operate the battery system in a normal mode to maintain a state of charge (SOC) of the battery system within a normal mode SOC range. In the normal mode, the battery management system may maintain a normal charging SOC limit and a normal discharging SOC limit.

Upon receipt of an indication of the predicted disturbance from the communication module, the battery system may be transitioned to a preconditioning mode. In various embodiments, the predicted disturbance may be a weather disturbance and/or a supply-side disturbance of the electrical utility. The state of charge may be maintained within a preconditioning mode SOC range that exceeds the normal SOC range. In the precondition mode, the battery controller may selectively disable a delayed charging operation.

In various embodiments, the system may be configured to detect an actual disturbance in the service of the electrical utility. The actual disturbance may be a blackout condition or a brownout condition. Upon detection of an actual disturbance, the system transitions to a backup mode. In the backup mode, the system may provide electrical energy from the battery system to an external load. In some embodiments, the electrical utility may be the external load. In other embodiments, the external load may be a device configured to receive electrical power from the electrical utility. In the backup mode, the battery management system may permit discharge of the battery system to a backup discharge threshold. The backup discharge threshold may be lower than a normal discharge threshold that is maintained in the normal mode.

In some embodiments, a user interaction component may permit a user to specify one or more user preferences relating to operation of the battery system in the preconditioning mode and/or the backup mode. Such preferences may be specified via a user interface module. The user interface module may further be configured in some embodiments to receive the indication of the predicted disturbance from a user.

### BRIEF DESCRIPTION OF THE DRAWINGS

Non-limiting and non-exhaustive embodiments of the disclosure are described, including various embodiments of the disclosure, with reference to the figures, in which:

FIG. 1 illustrates a block diagram of an exemplary battery system in a vehicle 100 that may be operated in a normal mode, a preconditioning mode, and a backup mode consistent with embodiments disclosed herein.

FIG. 2 illustrates a conceptual representation of a battery system having a first SOC range associated with a normal mode and a second SOC range associated with a backup preconditioning mode consistent with embodiments of the present disclosure.

FIG. 3 illustrates a graph over time of a SOC of a battery system operating in a normal mode, a backup preconditioning mode, and a backup mode consistent with embodiments of the present disclosure.

FIG. 4 illustrates a flow chart of a method for selectively configuring a battery system in a normal mode, a backup preconditioning mode, and a backup mode in response to a predicted event that may result in disruption of service by an electrical utility.

FIG. 5 illustrates a block diagram of a system that may be utilized in implementing certain embodiments of the systems and methods disclosed herein.

FIG. 6 illustrates an embodiment of a stationary battery system that may be operated in a normal mode, a preconditioning mode, and a backup mode consistent with embodiments disclosed herein.

### DETAILED DESCRIPTION

The embodiments of the disclosure will be best understood by reference to the drawings, wherein like parts are designated by like numerals throughout. It will be readily understood that the components of the disclosed embodiments, as generally described and illustrated in the figures herein, could be arranged and designed in a wide variety of different configurations. Thus, the following detailed description of embodiments of the systems and methods of the disclosure is not intended to limit the scope of the disclosure, as claimed, but is merely representative of possible embodiments of the disclosure. In addition, the steps of a method do not necessarily need to be executed in any specific order, or even sequentially, nor need the steps be executed only once, unless otherwise specified.

In some cases, well-known features, structures or operations are not shown or described in detail. Furthermore, the described features, structures, or operations may be combined in any suitable manner in one or more embodiments. It will also be readily understood that the components of certain embodiments, as generally described and illustrated in the figures herein, could be arranged and designed in a wide variety of different configurations.

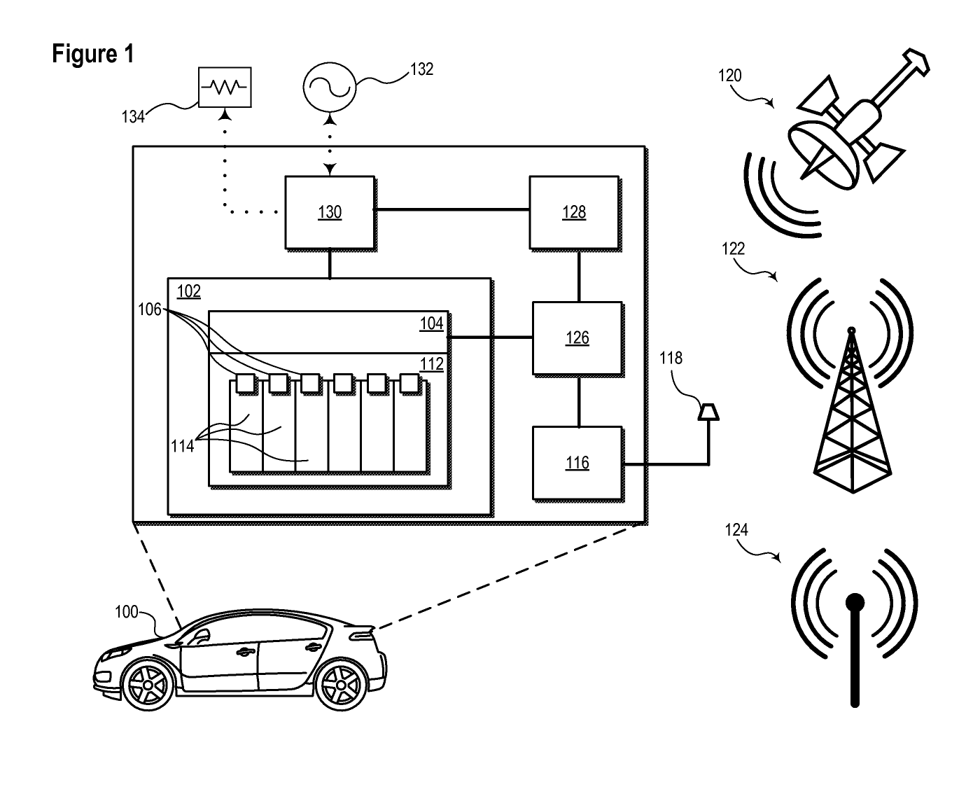

FIG. 1 illustrates a block diagram of an exemplary battery system 102 in a vehicle 100 that may be operated in a normal mode, a preconditioning mode, and a backup mode consistent with embodiments disclosed herein. The vehicle 100 may be a motor vehicle, a marine vehicle, an aircraft, and/or any other type of vehicle, and may include an internal combustion engine (“ICE”) 126, which in turn is coupled to an electrical generator 128. The electrical generator 128 may be driven by the ICE 126 and may provide power to an electric power conversion system 130. The electric power conversion system 130 may store power in the battery 102. In alternative embodiments, a fuel cell system may generate electrical energy in place of the ICE 126 and electrical generator 128. Power from the battery 102 may be used to power an electric motor drivetrain, a hybrid engine drivetrain, and/or any other type of drivetrain suitable for incorporating the systems and methods disclosed herein. As one of skill in the art will appreciate other techniques may also be used to generate power that is stored in the battery 102, including regenerative braking and other energy saving techniques.

The vehicle 100 may include a battery system 102 that, in certain embodiments, may be an HV battery system. The HV battery system may be used to power electric drivetrain components (e.g., as in an electric, hybrid, or FC power system). In further embodiments, the battery system 102 may be a low voltage battery (e.g., a lead-acid 12V automotive battery) and may be configured to supply electric energy to a variety of vehicle 100 systems including, for example, vehicle starter systems (e.g., a starter motor), lighting systems, ignition systems, and/or the like.

The battery system 102 may include a battery management system 104. The battery management system 104 may be configured to monitor and control certain operations of the battery system 102. For example, the battery management system 104 may be configured to monitor and control charging and discharging operations of the battery system 102. Among other things, the battery management system 104 may monitor the condition of a battery while in use in order to prevent over-discharge of the battery and/or over-discharge of one or more individual modules. Over-discharge of a battery may result in damage to the battery and, accordingly, mitigating and/or preventing over-discharge of a battery may prolong the useful lifespan of the battery system. In certain embodiments, the battery management system 104 may be communicatively coupled with one or more sensors 106 (e.g., voltage sensors, current sensors, temperature sensors, and/or the like) and/or other systems configured to enable the battery management system 104 to monitor and control operations of the battery system 102.

The battery system 102 may include one or more battery sections 112 suitably sized to provide electrical power to the vehicle 100. Each battery section 112 may include one or more modules 114. The modules 114 may comprise sub-packs, each of which may include one or more battery cells utilizing any suitable battery technology. Suitable battery technologies may include, for example, lead-acid, nickel-metal hydride (“NiMH”), lithium-ion (“Li-Ion”), Li-Ion polymer, lithium-air, nickel-cadmium (“NiCad”), valve-regulated lead-acid (“VRLA”) including absorbed glass mat (“AGM”), nickel-zinc (“NiZn”), molten salt (e.g., a ZEBRA battery), nickel manganese cobalt (“NMC”), lithium iron phosphate (“LFP”), lithium manganese oxide (“LMO”), and/or other suitable battery technologies and combinations thereof (e.g., mixed-chemistry battery technologies). In various embodiments, the battery controller 104 may be configured to provide information to and/or receive information from other systems included in the vehicle 100, such as a communications module 116. In certain embodiments, the battery management system 104 may be configured, at least in part, to provide information regarding the battery system 102 to a user of the vehicle 100. Such information may include, for example, battery state of charge information, battery operating time information, battery operating temperature information, and/or any other information regarding the battery system 102.

Each module 114 may be associated with a sensor 106 configured to measure one or more parameters (e.g., voltage, current, impedance, temperature, etc.) associated with each battery module 114. Although FIG. 1 illustrates separate sensors 106 associated with each module 114, in some embodiments a sensor configured to measure various parameters associated with a plurality of modules 114 may also be utilized. The parameters measured by sensor 106 may be provided to battery management system 104. Using the electrical parameters, battery management system 104 and/or any other suitable system may coordinate the operation of battery system 102.

The battery management system 104 may be configured to maintain the SOC of battery system 102 within a certain range during normal operation. In various embodiments, the SOC of the battery system 102 may be determined or estimated from one or more measured parameters, such as open circuit voltage, temperature, etc. In order to maintain the SOC of the battery system 102 within a particular range, the battery management system 104 may selectively activate ICE 126 to generate power that may then be stored in battery 102. Selective operation of the ICE 126 may prevent over-depletion of battery system 102 while the vehicle 100 is in operation. When the SOC of battery system 102 exceeds a specified threshold, the ICE 126 or other power system may be stopped in order to prevent overcharging battery system 102.

Electrical energy from an electrical utility 132 may also be used to charge the battery 102. The electric power conversion system 130 may convert electrical power received from the electrical utility 132 as appropriate for storage in battery system 102. For example, the electric power conversion system 130 may be configured to receive an input voltage between 110V and 240V with a nominal alternating current of 60 hertz. The electric power conversion system 130 may convert the power to an appropriate voltage for charging battery system 102. Further, the electric power conversion system 130 will also include a power inverter to allow the conversion of configured to convert electrical energy stored in the battery system to an alternating current that may be transmitted using the electrical power distribution system.

In one specific embodiment, the range of the state of charge during normal operation may be maintained between approximately 30% and 80%. This range may be maintained by connecting vehicle 100 to the electrical utility 132 and/or by selectively activating ICE 126 and generating electrical power using electrical generator 128.

In various embodiments consistent with the present disclosure, the SOC range may be extended to store additional electrical energy that may be used during a disruption in electrical service due, for example, to weather conditions, projected disruptions in an electrical power distribution system, and the like. In such conditions, the upper range of the state of charge may be increased, the lower range of the state of charge may be decreased, or both. Further, the battery system may be configured to charge up to a maximum state of charge in anticipation of a potential disruption in electrical service.

Accumulating electrical energy in a battery system prior to a disruption of service of an electrical utility may provide owners of vehicles with battery systems consistent with the present disclosure with increased value by increasing the probability that vehicle 100 will be charged to the greatest extent possible in case of a power outage or other disturbance. A fully charged vehicle, for example, may permit the owner the greatest possible opportunity to use vehicle 100 during the outage and may maximize the range of the vehicle during the outage. Further, vehicle 100 may provide valuable in the form of ancillary applications, such as providing backup power to the owner of the vehicle 100, or permitting the owner to sell back electricity to the electrical utility at advantageous times (e.g., periods of peak demand or other supply-side disruption, etc.). In some embodiments, the owner of vehicle 100 may store energy in the battery system during times of low energy demand and may sell energy stored in the battery system during times of high energy demand. Additionally, charging of batteries may be delayed by the vehicle until the cost of energy is lower. In the event of a predicted outage, however, various embodiments may be configured to begin charging the battery system without regard for the higher cost of electricity at that time.

In some embodiments, an indication of a potential disruption in electrical service may be transmitted to vehicle 100 in a variety of ways. The communications module 116 may be coupled to a receiver 118. The communications module 116 may also be in communication with the battery management system 104. The receiver 118 may be configured to receive information from a satellite network 120, a cellular telephone network 122, and/or a local area network 124. In various embodiments, the receiver 118 may be a part of a vehicle telematics system, such as the ONSTAR® service available from General Motors Company. The receiver may allow for information to be sent and/or received via the Internet. In one embodiment, a location of vehicle 100 may be determined using information from the Global Positioning System and information regarding a potential disruption in electrical service may be obtained from the cellular telephone network 122 and/or the local area network 124. In various embodiments, the local area network 124 may communicate using a variety of physical media and/or communication protocols, including but not limited to IEEE 802.11 family of standards, Radio Data System (RDS), Bluetooth®, wired network protocols (e.g., Ethernet), and the like. In some embodiments an indication of a potential disruption may be obtained from sources available on the Internet that provide weather forecasts. One such provider of on-line weather information may be weather.com. Indications of severe weather (e.g., storm warnings or advisories, wind warnings or advisories, and the like) may provide information regarding a potential disruption in electrical service.

Based on the information regarding the potential for disruption in electrical service, vehicle 100 may adjust the range of the SOC of the battery system 102 and precondition the battery 102 for use as a backup source of electrical power. Preconditioning the battery may involve charging the battery up to the increased maximum state of charge. Further, preconditioning the battery may, in certain embodiments, involve activating ICE 126 to generate electrical power that is stored in the battery 102 before or during an outage of an electrical service.

During an outage of an electrical service or other times (e.g., during a period of peak demand on an electrical grid, during a period of decreased power generation, etc.), energy stored in battery 102 may be provided to one or more external loads 134. In various embodiments, the electrical utility 132 may receive electrical energy drawn from the battery 102, and thus, may be referred to as an external load.

Disturbances associated with the operation of the electrical utility may be referred to as supply-side disturbances. The electric power conversion system 130 may be configured to provide an appropriate electrical output to power external load 134 and/or may be transferred to the electrical utility 132. In some embodiments, the external load 134 may comprise one or more circuits within a home of an owner of the vehicle 100. For example, a user may select certain loads in the user's home that may draw power or may provide uninterrupted power supply for business use at home or for medical reasons from battery 102 during an electrical outage. Such loads may typically draw power from the electrical utility 132 during a period of normal operation of the electrical utility 132.

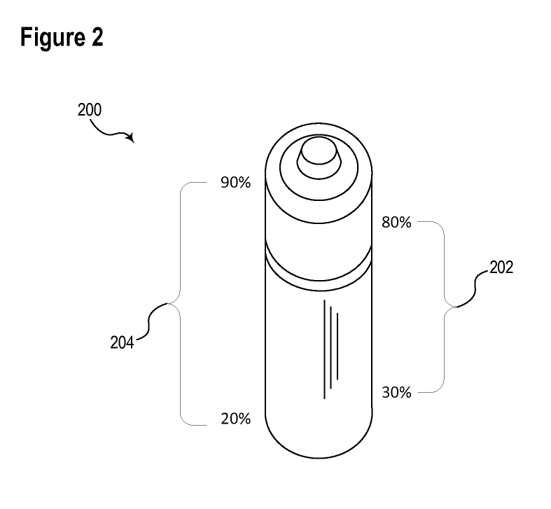

FIG. 2 illustrates a conceptual representation of a battery system 200 operable in a first SOC range 202 in a normal mode and a second SOC range 204 in a backup preconditioning mode consistent with embodiments of the present disclosure. The first SOC range 202 may be selected to maximize the lifecycle of the battery. Further, operation of the battery system within this range may permit the battery system to more effectively employ energy recovery techniques, such as regenerative braking. As one of skill in the art is aware, if a battery system is at or near a charging threshold, additional energy from a regenerative braking system may not be recovered. The first SOC range 202 may be determined by a wide variety of factors, including prolonging battery life, maintaining a moderate temperature in the battery system, providing an adequate battery energy reserve for typical conditions, accommodating various driving conditions, and the like. In one embodiment, the first SOC range 202 may be between about 30% and about 80%. In other embodiments, the first SOC range may extend above 80% and/or below 30%. A wide variety of possible ranges of the first SOC range 202 are contemplated by the present disclosure.

The second SOC range 204 may be selected to maximize the electrical energy stored in the battery system 200 during a disruption in the service of an electrical utility. In addition to making additional energy available for operation of a vehicle or for backup use during a disruption in service by an electrical utility, periodic operation of the battery system 200 outside of the boundaries of the first SOC range 202 may provide some advantages. For example, such operation may refresh the battery if the battery system is used infrequently.

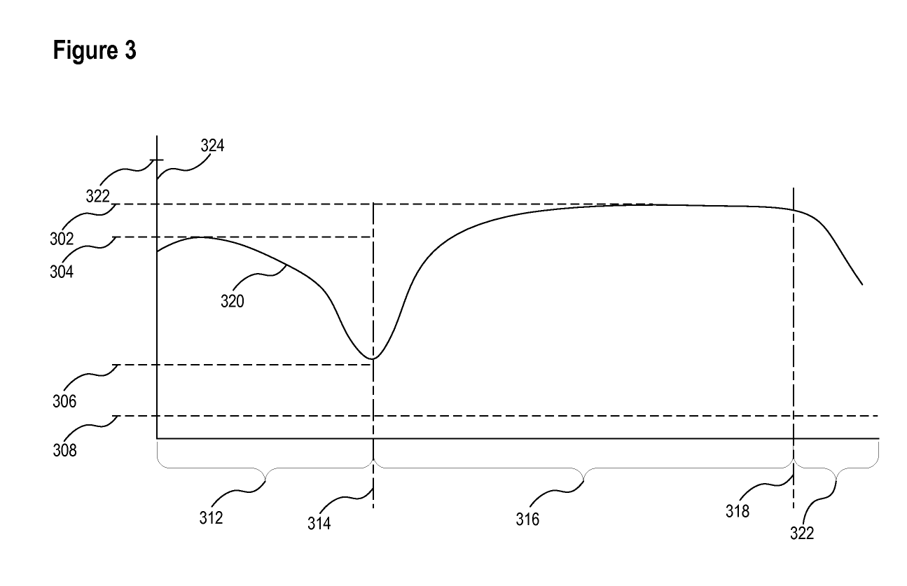

FIG. 3 illustrates a graph over time of a SOC 320 of a battery system operating in a normal mode 312, a backup preconditioning mode 316, and a backup mode 322 consistent with embodiments of the present disclosure. In the normal mode 312, the battery system may operate between an upper threshold 304 and a lower threshold 306. In one embodiment, the upper threshold 304 may represent approximately 80% SOC and the lower threshold 306 may represent approximately 30% SOC. Operation of the battery system between the upper threshold 304 and the lower threshold 306 may be selected to maximize the lifecycle of the battery system.

In the normal mode 312, the battery system may maintain SOC 320 between the lower threshold 306 and 304. The battery system may, in certain embodiments operate an electrical generator and/or generate electrical energy by regenerative braking or other techniques. The electrical energy may be consumed by operation of an electrical drivetrain.

In the illustrated embodiment, at 314, an event is predicted that may disrupt typical operation of an electrical utility service. In various embodiments, any number of events may be predicted that could potentially disrupt the typical operation of an electrical utility service. For example, the predicted event 314 may be a storm that triggers the transition between the normal mode and the backup preconditioning mode. In other examples, such events may include periods of peak demand on an electrical grid, periods of decreased power generation, and the like. During such events, the electrical utility service may continue to operate, but may not operate in typical condition. Following the prediction, the battery system may transition to a backup preconditioning mode 316.

In the backup preconditioning mode 316, the battery system may begin to accumulate electrical energy. As illustrated in the graph over time of the SOC 320, the battery system begins accumulating electrical energy following the predicted event 314. In the backup preconditioning mode 316, the upper threshold 304 may be raised to a higher threshold 302. The higher threshold 302 may allow the battery system to store a greater amount of energy that may be used during a disruption in the electrical utility service. As illustrated in the graph over time of the SOC 320 may increase until the SOC of the battery system approaches the higher threshold 302. The battery system may discontinue charging the battery system as the SOC reaches the higher threshold 302.

At 318, a disruption in an electrical utility service may occur and the battery system may begin operating in a backup mode 322. In the backup mode 322, electrical energy may be drawn from the battery and provided to one or more external loads. In various embodiments, a battery system may provide electrical energy back to the utility system during times of decreased electrical production or transmission.

The threshold 306 in the normal mode 312 may be lowered in the backup mode 316 to threshold 308. The lower threshold may allow additional electrical energy to be drawn from the battery, and may therefore, permit the battery system to continue to operate for a longer period of time. The additional electrical energy may allow the battery system to power a vehicle for a greater distance or longer period of time or may permit a battery system to provide backup power for a longer period of time.

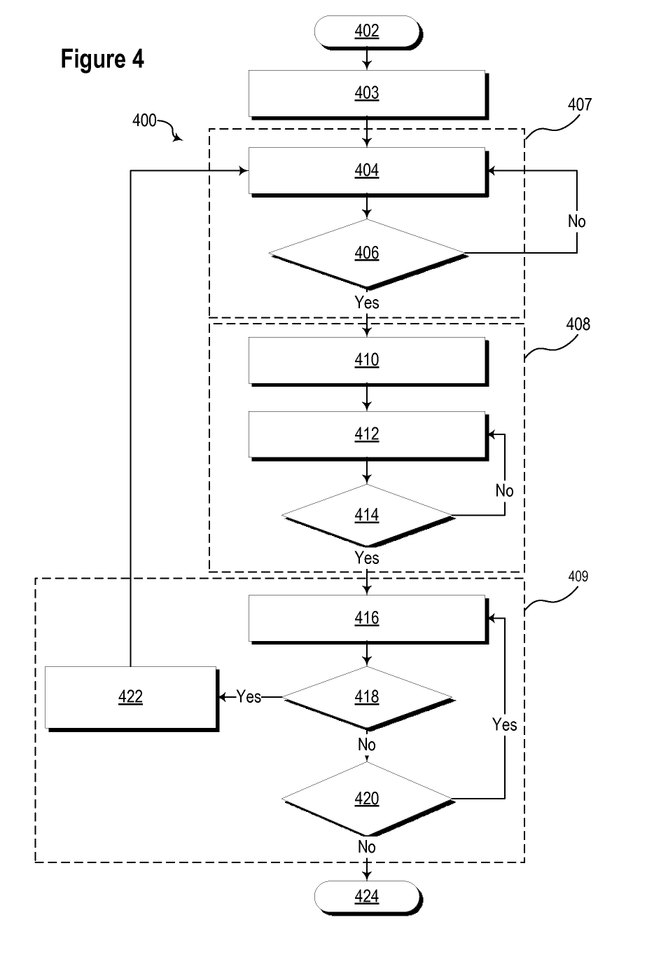

FIG. 4 illustrates a flow chart of a method 400 for selectively configuring a battery system in a normal mode 407, a backup preconditioning mode 408, and a backup mode 409 in response to a predicted event that may result in disruption of service by an electrical utility. At 402, method 400 may begin. A user may provide one or more battery preconditioning preferences at 403. In various embodiments, a variety of user-specified parameters are consistent with the present disclosure. For example, the user may be permitted to specify the types of events that may trigger a transition between the normal mode and the preconditioning mode. The user may, for example, elect to enable the preconditioning mode in response to a prediction of a disruption in response to a weather-related event, but may elect to disable the preconditioning mode in response to a potential supply-side disruption. Still further, the user-specified preferences may permit a user to specify that only certain types of weather related events should trigger a transition to a preconditioning mode.

At 404, the battery system may be operated within normal parameters. In various embodiments, operation in the normal mode 407 may involve maintaining the SOC of the battery system with a first SOC range. In one specific embodiment, the first SOC range may be between 30% SOC and 80% SOC.

At 406, it may be determined if an indication of a potential disturbance has been received. As previously described, a variety of disturbances are contemplated, including disturbances caused by weather, earthquakes, reduced electrical generation capacity, periods of predicted high electrical demand, and the like. Until an indication of a potential disturbance is received, the battery system may continue to operate in the normal mode 407.

Upon receipt of an indication of a potential disturbance, the battery system may transition to the backup preconditioning mode 408. At 410, the SOC range may transition to a second SOC range that is greater than the first SOC range. In one specific embodiment, the second SOC range may be between 20% and 90% SOC. In some embodiments, the lower value of the SOC range may not be adjusted in the backup preconditioning mode 408, since operation of the battery system in the backup preconditioning mode may primarily serve to accumulate electrical energy rather than drawing power from the battery system.

At 412, the battery system may begin to accumulate electrical energy that may be used during operation of the battery system in the backup mode 409. In some embodiments, the battery system may only transition to the backup preconditioning mode when the battery system is connected to an external power source (e.g., an electrical utility). Still further, in some embodiments where the battery system may selectively activate a source of electrical energy (e.g., an ICE coupled to an generator), the electrical source may be activated to accumulate electrical energy regardless of whether the battery is connected to an external source where possible (e.g., the ICE has fuel and is not stored in a confined space, such as a garage).

At 414, the battery system may determine whether an indication of a disruption of service by an electrical utility has been detected. Until the indication of disruption of service has been detected, the battery system may continue to accumulate electrical energy until the battery reaches the maximum SOC permitted in the preconditioning mode 408. As described previously in connection with FIG. 3, charging may be discontinued in the backup preconditioning mode 316 once the battery SOC reaches the maximum SOC threshold.

Returning to a discussion of FIG. 4, a variety of circumstances or events may trigger the disruption of service of the electrical utility. For example, the battery system may detect a blackout condition (i.e., a complete disruption of electrical service provided by the electrical utility). Alternatively, the disruption may be associated with a “brownout” and may involve a detection that the voltage or frequency of the electrical utility have deviated from nominal levels. At 416, the battery system may operate in the backup mode by providing electrical energy stored in the battery system to one or more external loads and/or to the electrical utility.

At 418, the battery system may determine whether an indication of abatement of the potential disturbance has been received. For example, such an indication may include detection that power to an area affected blackout has occurred. In another example, the indication may include a determination that conditions indicative of a brownout (e.g., aberration from a nominal frequency and/or voltage) have abated. Still further, the indication of abatement may comprise the passage of time in certain embodiments consistent with the present disclosure. If the conditions have abated, the charge threshold and the depletion limit may be restored to the limits associated with the normal mode at 422, and method 400 may return to 404.

At 420, the battery system may determine if the battery has reached the depletion threshold. As discussed above, over-discharge of a battery system may result in permanent damage to a battery system. Accordingly, the control system may prevent discharge of the battery below the depletion threshold. If the battery SOC is below the depletion threshold, method 400 may end at 424. If the battery SOC is above the depletion threshold, method 400 may return to 416.

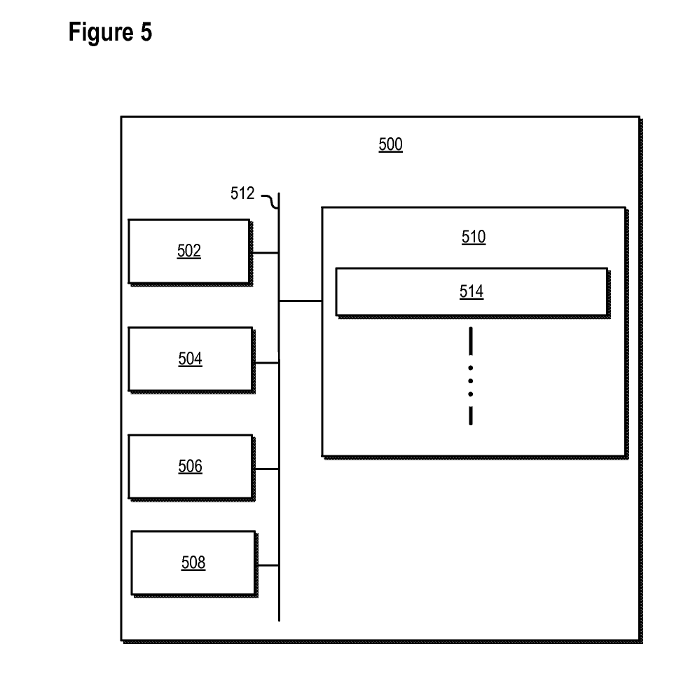

FIG. 5 illustrates a block diagram of a system 500 that may be utilized in implementing certain embodiments of the systems and methods disclosed herein. In certain embodiments, the system 500 may be an on-board vehicle computer, a battery controller, and/or any other type of system suitable for implementing the disclosed systems and methods. The system 500 may include, among other things, one or more processors 502, random access memory (RAM) 504, a communications interface 506, a user interface 508, and a non-transitory computer-readable storage medium 510. The processor 502, RAM 504, communications interface 506, and computer-readable storage medium 510 may be communicatively coupled to each other via a common data bus 512. In some embodiments, the various components of the computer system 500 may be implemented using hardware, software, firmware, and/or any combination thereof.

The communications interface 506 may be any interface capable of communicating with other computer systems, peripheral devices, and/or other equipment communicatively coupled to system 500. For example, the communications interface 506 may allow the system 500 to communicate with other computer systems (e.g., computer systems associated with external databases and/or the Internet), allowing for the transfer as well as reception of data from such systems. The communications interface 506 may include, among other things, a cellular modem, a satellite data transmission system, a wireless data interface, and/or any other suitable device that enables the computer system 500 to communicate electronic data.

Processor 502 may include one or more general purpose processors, application specific processors, programmable microprocessors, microcontrollers, digital signal processors, FPGAs, other customizable or programmable processing devices, and/or any other devices or arrangement of devices that are capable of implementing the systems and methods disclosed herein. Processor 502 may be configured to execute computer-readable instructions stored on non-transitory computer-readable storage medium 510.

Computer-readable storage medium 510 may store other data or information as desired. In some embodiments, the computer-readable instructions may include computer executable functional modules 514. For example, the computer-readable instructions may include one or more functional modules 514 configured to implement all or part of the functionality of the systems and methods described above.

Specific functional models 514 that may be stored on computer-readable storage medium 510 that are configured to perform the various functions and methods described herein. In some embodiments, computer-readable storage medium may include, among other things, a battery control module. The battery control module may be configured to operate the battery system in a normal mode to maintain a state of charge of the battery system within a normal mode SOC range. The battery control module may transition to a preconditioning mode upon receipt of an indication of a predicted disturbance. In the preconditioning mode, the SOC range of the battery system may be expanded to increase the amount of energy available during a potential disruption in electrical service. In the preconditioning mode, the system may accumulate electrical energy in the battery up to a threshold. Further, the battery control module may be configured to operate the battery system in a backup mode upon the occurrence of an actual disturbance. In the backup mode, the battery system may provide electrical energy from the battery to an external load.

In various embodiments, computer-readable storage medium may further comprise a user interaction module. The user interaction module may be configured to allow a user to tune various preferences associated with the operation of the battery system in the preconditioning mode. For example, in certain areas high-wind warnings may be likely to trigger a power outage because power lines may be in close proximity to tree limbs or other hazards that are likely to disrupt electrical utility service based on wind. In other areas, however, the electrical utility service lines may be buried underground, and therefore, high wind may be less likely to cause an electrical outage. The example of permitting a user to specify a preference for conditions in which the battery system may transition to the preconditioning mode are merely exemplary of a wide variety of possible preferences that may be specified by a user according to various embodiments.

The system and methods described herein may be implemented independent of the programming language used to create the computer-readable instructions and/or any operating system operating on the computer system 500. For example, the computer-readable instructions may be written in any suitable programming language, examples of which include, but are not limited to, C, C++, Visual C++, and/or Visual Basic, Java, Perl, or any other suitable programming language. Further, the computer-readable instructions and/or functional modules 514 may be in the form of a collection of separate programs or modules, and/or a program module within a larger program or a portion of a program module. The processing of data by computer system 500 may be in response to user commands, results of previous processing, or a request made by another processing machine. It will be appreciated that computer system 500 may utilize any suitable operating system including, for example, Unix, DOS, Android, Symbian, Windows, iOS, OSX, Linux, and/or the like.

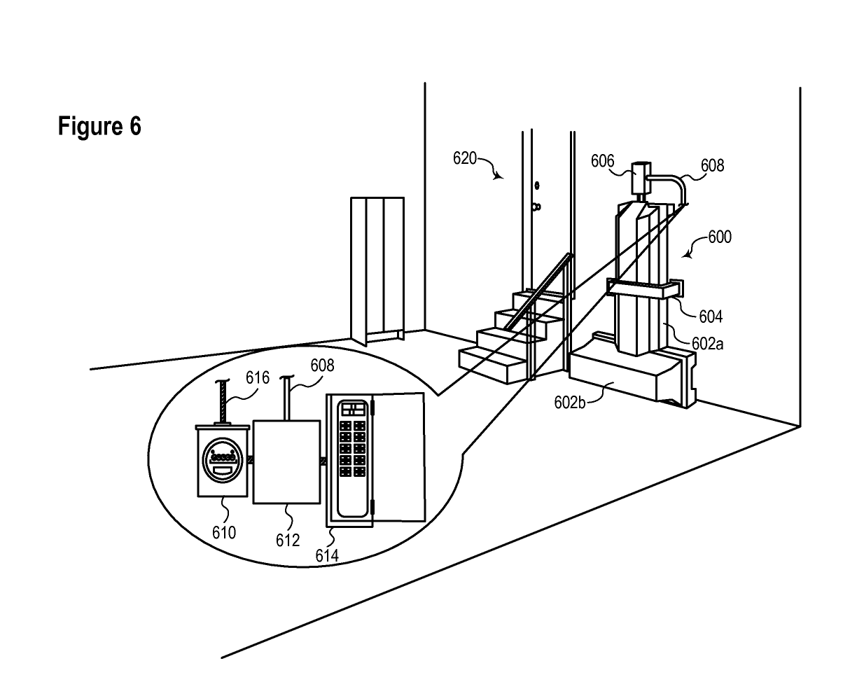

FIG. 6 illustrates an embodiment of a stationary battery system 600 that may be operated in a normal mode, a preconditioning mode, and a backup mode consistent with embodiments disclosed herein. In various embodiments, stationary battery system 600 may be installed at a building 620 that may represent a home, an office, a medical facility, a renewable energy generation site, or at a variety of other locations. The battery system 600 may include one or more battery sections 602a, 602b. Each of the battery sections 602a, 602b may comprise a plurality of battery modules. The battery system 600 may be held in place using a securing component 604.

An electric power conversion system 606 may be in electrical communication with the battery system 600 and an electrical utility system. Electric power conversion system 606 may include electronics to convert alternating current to direct current and vice versa. The electric power conversion system 606 may also be configured to transform the voltage of electrical energy, either for storage in the battery system 600, for use in the building 620, or for transmission via the electrical utility system.

A transfer switch 612 may be disposed between an electrical meter 610 and a circuit breaker 614. Electrical energy may be provided to various circuits in the building 620 through the circuit breaker 614. The battery system 600 may be in electrical communication with the transfer switch via a conductor 608. The transfer switch 612 may selectively direct electricity from the electrical utility to the building 620 and/or the battery system 600. Further, the transfer switch 612 may selectively isolate the battery system 600 from the electrical utility. Isolating the battery system 600 from the electrical utility may be beneficial during certain periods (e.g., during electrical outages) to ensure that electrical conductors believed by utility personnel to be inactive are not electrified by sources (e.g., battery system 600) that are outside of the control of such personnel.

While specific embodiments and applications of the disclosure have been illustrated and described, it is to be understood that the disclosure is not limited to the precise configurations and components disclosed herein. Accordingly, many changes may be made to the details of the above-described embodiments without departing from the underlying principles of this disclosure. The scope of the present invention should, therefore, be determined only by the following claims.

1. A battery system configured to operate in a preconditioning mode based upon a predicted disturbance of service of an electrical utility, comprising:
a battery system configured to store electrical energy;
a communication module configured to receive an indication of a predicted disturbance of an electrical utility;
a battery management system in communication with the battery system and the communication module, the battery management system configured to:
operate the battery system in a normal mode to maintain a state of charge (SOC) of the battery system within a normal mode SOC range;
receive the indication of the predicted disturbance from the communication module;
transition the battery system to a preconditioning mode upon receipt of the indication of the predicted disturbance and maintain the state of charge of the battery system within a preconditioning mode SOC range, the preconditioning mode SOC range exceeding the normal SOC range; and
accumulate electrical energy in the battery in the preconditioning mode up to a charge capacity cutoff threshold.

2. The system of claim 1, wherein the predicted disturbance comprises at least one of a weather disturbance.

3. The system of claim 1, wherein the battery management system is further configured to:
detect an actual disturbance in the service of the electrical utility;
transition to a backup mode upon detection of the actual disturbance; and
provide electrical energy from the battery system to an external load.

4. The system of claim 3, wherein the battery management system is further configured to permit discharge of the battery system to a backup discharge threshold in the backup mode, the backup discharge threshold being lower than a normal discharging SOC that is maintained in the normal mode.

5. The system of claim 3, wherein the actual disturbance comprises at least one of a blackout condition and a brownout condition.

6. The system of claim 3, wherein the external load comprises the electrical utility.

7. The system of claim 3, wherein the external load comprises a device configured to receive electrical power from the electrical utility.

8. The system of claim 1, further comprising:
a user interaction component configured to permit a user to specify a user preference;
wherein the battery management system is further configured to operate the battery system in the preconditioning mode based on the user preference.

9. The system of claim 1, further comprising a user interface module configured to receive the indication of the predicted disturbance from a user.

10. The system of claim 1, wherein the preconditioning mode SOC range comprises a charge threshold of about 90%.

11. The system of claim 1, wherein the normal charging SOC range comprises a normal charging SOC limit and a normal discharging SOC limit, and the battery management system is further configured to operate the battery system in the backup mode in a backup SOC range.

12. The system of claim 1, wherein the communication module comprises a communications interface comprising at least one of a wireless data network interface, a wired data network interface, a cellular data interface, a satellite data interface, and a radio data system interface.

13. The system of claim 1, wherein the battery controller may selectively disable a delayed charging operation in the preconditioning mode.

14. A method of operating a battery system configured to transition between a normal mode and a preconditioning mode based upon a predicted disturbance of service of an electrical utility, comprising:
operating the battery system in a normal mode and maintaining a state of charge (SOC) of the battery system within a normal mode SOC range;
receiving an indication of a predicted disturbance of service of the electrical utility from an external source;
transitioning the battery system to a preconditioning mode upon receipt of the indication of the predicted disturbance and maintaining the SOC of the battery system within a preconditioning mode SOC range, the preconditioning mode SOC range exceeding the normal SOC range; and
accumulating electrical energy in the battery in the preconditioning mode up to a charge capacity cutoff threshold.

15. The method of claim 14, wherein the predicted disturbance comprises at least one of a weather disturbance and a supply-side disturbance of the electrical utility.

16. The method of claim 14, further comprising:
operating the battery system in a backup mode and providing electrical energy from the battery system to an external load upon detection of an actual disturbance.

17. The method of claim 16, wherein the actual disturbance comprises at least one of a blackout and a brownout.

18. The method of claim 14, further comprising:
receiving at least one user-specified battery preconditioning preference; and
adjusting at least one of the operation of the battery system in the preconditioning mode based on the at least one user-specified battery preconditioning preference.

19. The method of claim 14, further comprising:
selectively disabling a delayed charging operation in the preconditioning mode.

20. A battery system configured to transition between a normal mode and a preconditioning mode based upon an indication of predicted weather, comprising:
an electrical drivetrain configured to power a vehicle;
a battery system configured to store electrical energy and to provide electrical energy to the electrical drive;
a communication module configured to receive an indication of a weather disturbance through a communication interface;
a battery management system in communication with the battery system and the communication module, the battery management system configured to:
operate the battery system in a normal mode to maintain a state of charge (SOC) of the battery system between a first charge threshold and a first discharge threshold;
receive the indication of the weather disturbance;
transition the battery system to a preconditioning mode upon receipt of the indication of the weather disturbance and to accumulate electrical energy up to a second charge threshold, the second charge threshold being higher than the first charge threshold; and
transition the battery system to a backup mode upon receipt of an indication of actual disturbance in the service of the electrical utility and to provide electrical energy from the battery to an external load to a second discharge threshold, the second discharge threshold being lower than the first discharge threshold.
